(19) United States
(12) Patent Application Publication
(10) Pub. No.: US 2016/0365015 A1
(43) Pub. Date: Dec. 15, 2016

(54) Vehicle Signage System

(71) Applicant: Kenneth Young, La Plata, MD (US)

(72) Inventor: Kenneth Young, La Plata, MD (US)

(21) Appl. No.: 14/736,998

(22) Filed: Jun. 11, 2015

(51) Int. Cl. G09F 21/04; G09F 7/18; B60J 5/00

(52) U.S. Cl. CPC G09F 21/048; B60J 5/00; G09F 7/18; G09F 2007/1847

(57) ABSTRACT

A vehicle signage system includes a vehicle door that has a first lateral edge, a second lateral edge and a bottom edge. A flexible panel has an outer surface, an inner surface, an upper edge, a lower edge, a first side edge and a second side edge. The panel has a length from the first side to the second side edge that is greater than a length of the vehicle door from the first lateral edge to the second lateral edge. The inner surface is abutted against an outside surface of the vehicle door. The panel extends to and around each of the first and second lateral edges. A pair of couplers is provided and each of the first and second lateral edges has one of the couplers mounted thereon such that the panel is releasably retained between the couplers and the vehicle door.

### BACKGROUND OF THE DISCLOSURE

### Field of the Disclosure

The disclosure relates to door signage devices and more particularly pertains to a new door signage device for placing advertisements or other messages on a vehicle door.

### SUMMARY OF THE DISCLOSURE

An embodiment of the disclosure meets the needs presented above by generally comprising a vehicle door that has a first lateral edge, a second lateral edge and a bottom edge. A flexible panel has an outer surface, an inner surface, an upper edge, a lower edge, a first side edge and a second side edge. The panel has a length from the first side to the second side edge that is greater than a length of the vehicle door from the first lateral edge to the second lateral edge. The panel is substantially transparent and has indicia thereon. The inner surface is abutted against an outside surface of the vehicle door. The panel extends to and around each of the first and second lateral edges. A pair of couplers is provided and each of the first and second lateral edges has one of the couplers mounted thereon such that the panel is releasably retained between the couplers and the vehicle door.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a panel of a vehicle signage system according to an embodiment of the disclosure.

FIG. 2 is a top perspective view of a clip of an embodiment of the disclosure.

FIG. 3 is a front in-use view of an embodiment of the disclosure.

FIG. 4 is an exploded perspective view of an embodiment of the disclosure.

FIG. 5 is a cross-sectional view of an embodiment of the disclosure taken along line 5-5 of FIG. 3.

### DESCRIPTION OF THE PREFERRED EMBODIMENT

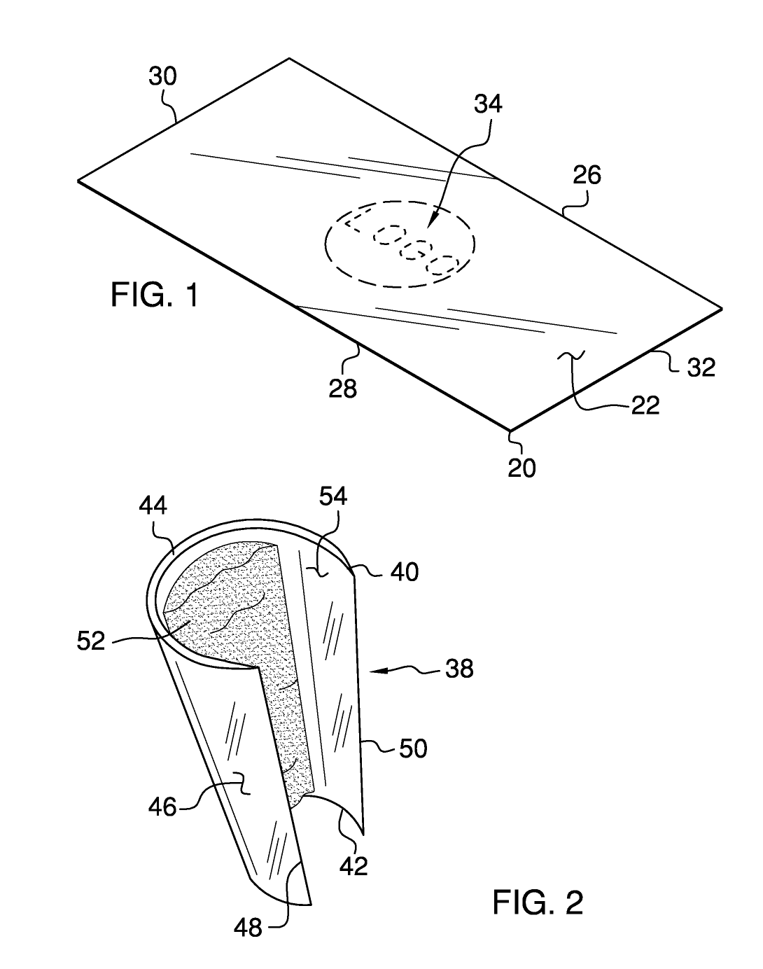

With reference now to the drawings, and in particular to FIGS. 1 through 5 thereof, a new door signage device embodying the principles and concepts of an embodiment of the disclosure and generally designated by the reference numeral 10 will be described.

As best illustrated in FIGS. 1 through 5, the vehicle signage system 10 generally comprises a vehicle door 12 that has a first lateral edge 14, a second lateral edge 16 and a bottom edge 18. The vehicle door 12 is a conventional door found on any conventional vehicle. A flexible panel 20 is provided that has an outer surface 22, an inner surface 24, an upper edge 26, a lower edge 28, a first side edge 30 and a second side edge 32. The panel 20 has a length from the first side edge 30 to the second side edge 32 which is greater than a length of the vehicle door from the first lateral edge 14 to the second lateral edge 16. The panel 20 may be opaque and colored though it may be preferred that the panel is substantially transparent such that it is not easily noticeable when positioned on the vehicle door 12. The panel 20 has indicia 34 thereon which may include, for instance, logos or other advertisements. The inner surface 24 of the panel 20 is abutted against an outside surface 36 of the vehicle door 12. The panel 20 extends to and around each of the first 14 and second 16 lateral edges. The panel 20 is comprised of a plastic material and is free of any adhesives.

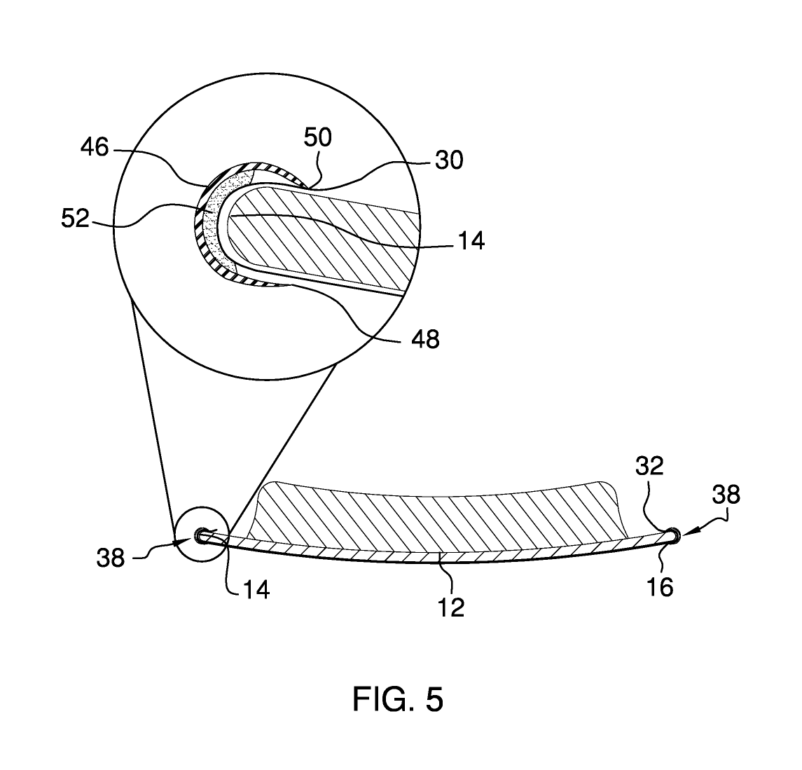

A pair of couplers 38 is provided. Each of the first 14 and second 16 lateral edges has one of the couplers 38 mounted thereon such that the panel 20 is releasably retained between the couplers 38 and the vehicle door 12. Each of the couplers 38 comprises a clip 40 that is elongated and has a first end 42, a second end 44 and a perimeter wall 46 extending between the first 42 and second 44 ends. The perimeter wall 46 is arcuate and a cross-section of the perimeter wall 46 taken perpendicular to a longitudinal axis extending through the first 42 and second 44 ends is C-shaped. The perimeter wall 46 has a first elongated edge 48 and a second elongated edge 50. Though not shown in FIG. 5, the first 48 and second 50 elongated edges may be abutted against and frictionally engage opposite sides of the vehicle door 12. The clip 40 may be substantially transparent so that it is not easily noticeable when mounted on the vehicle door 12. An adhesive 52 is positioned on an interior 54 of the clip 40. The interior 54 receives the vehicle door 12 such that the adhesive 52 abuts the panel 12.

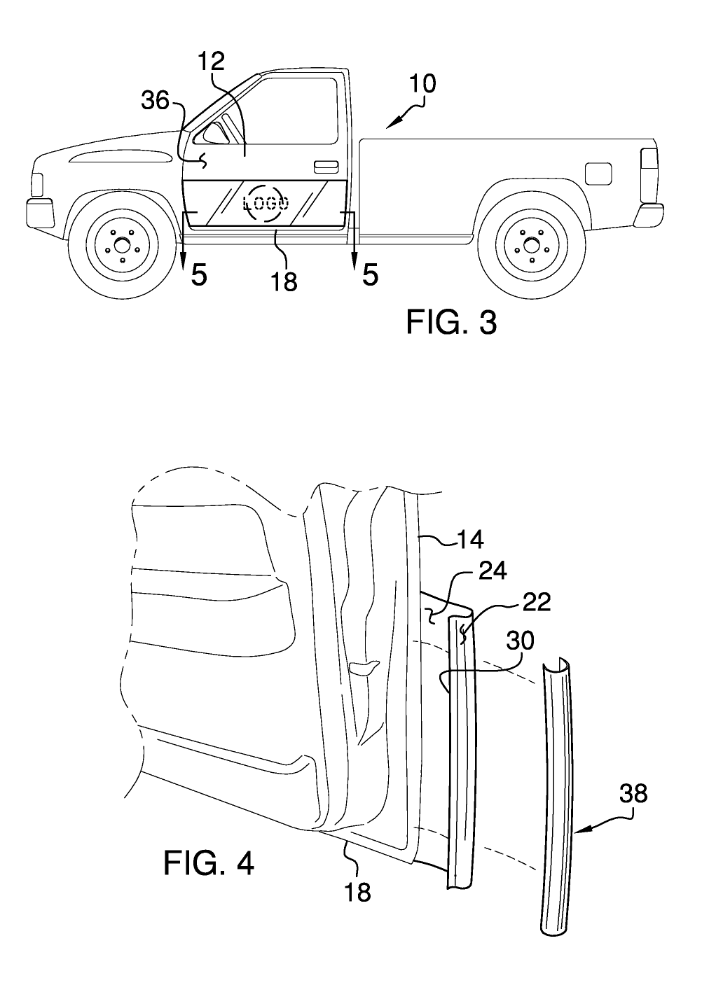

In use, the panel 20 is placed over the vehicle door 12 as described above and shown in FIG. 3. The panel 20 allows the vehicle door 12 to be easily adorned with advertizing material or other logos and messages. The panel 20, since it is not secured to the vehicle door 12, may be removed or replaced as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle signage system comprising:
a vehicle door having a first lateral edge, a second lateral edge and a bottom edge;
a flexible panel having an outer surface, an inner surface, an upper edge, a lower edge, a first side edge and a second side edge, said panel having a length from said first side edge to said second side edge being greater than a length of said vehicle door from said first lateral edge to said second lateral edge, said panel being substantially transparent, said panel having indicia thereon;
said inner surface being abutted against an outside surface of the vehicle door, said panel extending to and around each of said first and second lateral edges; and
a pair of couplers, each of said first and second lateral edges having one of said couplers mounted thereon such that said panel is releasably retained between said couplers and said vehicle door.

2. The vehicle signage system according to claim 1, wherein said couplers each comprise a clip.

3. The vehicle signage system according to claim 2, wherein said clip is elongated and has a first end, a second end and a perimeter wall extending between said first and second ends, said perimeter wall being arcuate and a cross-section of said perimeter wall taken perpendicular to a longitudinal axis extending through said first and second ends being C-shape.

4. The vehicle signage system according to claim 2, wherein said clip is substantially transparent.

5. The vehicle signage system according to claim 3, further including an adhesive being positioned on an interior of said clip, said interior receiving said vehicle door such that said adhesive abuts said panel.

6. A vehicle signage system comprising:
a vehicle door having a first lateral edge, a second lateral edge and a bottom edge, said vehicle door;
a flexible panel having an outer surface, an inner surface, an upper edge, a lower edge, a first side edge and a second side edge, said panel having a length from said first side edge to said second side edge being greater than a length of said vehicle door from said first lateral edge to said second lateral edge, said panel being substantially transparent, said panel having indicia thereon;
said inner surface being abutted against an outside surface of the vehicle door, said panel extending to and around each of said first and second lateral edges;
a pair of couplers, each of said first and second lateral edges having one of said couplers mounted thereon such that said panel is releasably retained between said couplers and said vehicle door, each of said couplers comprising:
a clip being elongated and having a first end, a second end and a perimeter wall extending between said first and second ends, said perimeter wall being arcuate and a cross-section of said perimeter wall taken perpendicular to a longitudinal axis extending through said first and second ends being C-shaped, said perimeter wall having a first elongated edge and a second elongated edge, said clip being substantially transparent; and
an adhesive being positioned on an interior of said clip, said interior receiving said vehicle door such that said adhesive abuts said panel.
